(19) United States
(12) Patent Application Publication
(10) Pub. No.: US 2004/0085061 A1
(43) Pub. Date: May 6, 2004

(54) Geartooth sensor with angled faced magnet

(76) Inventors: Nicholas F. Busch, Freeport, IL (US); Joseph K. Murdock, Freeport, IL (US); Robert E. Bicking, Freeport, IL (US)

Correspondence Address: Kris T. Fredrick, Honeywell International, Inc., 101 Columbia Road, P.O. Box 2245, Morristown, NJ, 07962, US

(21) Appl. No.: 10/287,397

(22) Filed: Nov. 4, 2002

(51) Int. Cl. G01B 7/30

(52) U.S. Cl. 324/207.2; 324/207.21; 324/207.25

(57) ABSTRACT

Magnetic sensor methods and systems for decreasing variations in switching angles thereof are disclosed. An angled face magnet can be angularly positioned adjacent one or more sensing elements of a magnetic sensor thereof. The angled face magnet can be configured to include a recessed portion into which the one or more of the sensing elements can be positioned. When the teeth of a target pass by the angled face magnet, it produces a magnetic signal, which is steeper in switching regions. The angle face magnet can thus alter a magnetic signal thereof, thereby decreasing variations in switching angles associated the magnetic sensors relative to a sensor target.

### TECHNICAL FIELD

The present invention is generally related to magnetic sensors. The present invention is also related to geartooth sensors in which a magnetically sensitive device senses a ferrous object or objects generally projecting from a rotating target and resembling the teeth of a gear. The present invention is additionally related to geartooth sensors utilized in automobile applications. The present invention is also related to geartooth sensors that exhibit variations in switching angles caused by sensor-to-target positioning tolerances.

### BACKGROUND OF THE INVENTION

Many different types of magnetic sensors are known to those skilled in the art. Certain magnetic sensors utilize a permanent magnet to provide a bias magnetic field that is distorted when a ferromagnetic object moves through a pre-selected detection zone. The distortion of the magnetic field is sensed by a magnetically sensitive component, which provides an output signal that changes to indicate the presence or absence of the ferromagnetic object within the detection zone. A common application of this type of sensor is a geartooth sensor, which is utilized in automotive applications. Sensors of this type can be used, for example, in the timing apparatus of an automobile engine and, alternatively, in association with automatic or anti-lock braking systems.

In general, in order to detect the presence of a geartooth within a detection zone of the geartooth sensor, a threshold value is first determined and subsequent signals received from a magnetically sensitive component are compared to the threshold value to determine the presence or absence of a ferromagnetic object (e.g., geartooth) within the detection zone. Thus, when the metal target is circular in shape, the sensing system is called a “geartooth sensor” from the resemblance of the target to a toothed mechanical gear. These geartooth sensors are often used in the automotive applications in which the target is linked to the crankshaft for use in engine control. Sensor designers continually seek refinement of the target system to improve engine control.

Several features of magnetic sensors, such as geartooth sensors, are important. The sensor must be able to be calibrated accurately so the output signals from a magnetically sensitive component precisely correspond to the passage of ferromagnetic teeth through the detection zone of the sensor. Additionally, it is desirable to manufacture the magnetic sensor so its overall size and number of components are minimized and its total cost can be reduced. The magnetically sensitive components utilized in magnetic sensors can comprise magnetoresistors, Hall effect elements, or other magnet-based transducer technology. Many different types of sensors have been developed that suit particular purposes. In certain magnetic sensors, the magnetically sensitive component must be positioned accurately during an active calibration so the output signals from the sensor are precisely responsive to the position of the geartooth, notwithstanding the possible variation in magnetic field strength and the uniformity of the magnetic field provided by the magnet.

As a preliminary note, the basic Hall sensor is simply a small sheet of semiconductor material. A constant voltage source forces a constant bias current to flow in the longitudinal direction in the semiconductor sheet. The output, a voltage measured across the width of the sheet, reads near zero if a magnetic field is not present. If the biased Hall sensor is placed in a magnetic field oriented transversely to the Hall current, the voltage output is in direct proportion to the strength of the magnetic flux component at right angles to the Hall cell. The basic Hall sensor is essentially a transducer that will respond with an output voltage change to an applied magnetic field.

An example of a magnetic sensor is the magnetic sensor disclosed in U.S. Pat. No. 5,596,272 to Busch, which describes a magnetic sensor with a beveled permanent magnet. The beveled surface intersects a first pole face at a preselected angle. The permanent magnet is associated with a magnetically sensitive component that comprises first and second magnetoresistive elements. Both of the magnetoresistive elements comprise two magnetoresistors. The four magnetoresistors are connected in electrical communication with each other to form a Wheatstone bridge that provides an output signal representative of the magnetic field strength in the sensing plane of the magnetically sensitive component. The beveled magnet thus provides a magnetic field, which relates to a magnetically sensitive component in such a manner that the position of a magnetic null in the sensing place is advantageously affected.

An example of another magnetic sensor is disclosed in U.S. Pat. No. 5,729,128 to Bunyer et al., which discloses a magnetic sensor comprising a permanent magnet, which has a first pole face and a second pole face. The first and second pole faces are generally perpendicular to an axial centerline, which extends along the central axis of the permanent magnet. A channel is formed in the permanent magnet in a direction along the centerline. Molding a magnet in a shape, which has a generally U-shaped cross section, can form the channel.

FIG. 1 illustrates a typical example of a conventional geartooth sensor. As indicated in FIG. 1, a gear 10 can be arranged for rotation about a central axis 12. A plurality of gear teeth 14 may be attached to the gear 10 for rotation through a detection zone of the geartooth sensor. The simplified schematic representation of the geartooth sensor in FIG. 1 can comprise a magnet 16 and a magnetically sensitive component 18. The magnetically sensitive component 18 can be a Hall effect element or an arrangement of magnetoresistors. Those skilled in the art can thus appreciate that the specific configuration of the magnetically sensitive component 18 is thus not limiting to the application of the circuit of the present invention.

In operation, a geartooth sensor, or proximity sensor, typically comprises a permanent magnet in association with a magnetically sensitive component, such as a Hall effect element or a magnetoresistive element. Sensors of this type are constructed in such a way that a ferromagnetic component passing through a predefined detection zone will cause the magnetically sensitive component to provide a signal identifying this event. The ferromagnetic object can be the teeth of a gear, whether or not the gear is intended to operate in the traditional manner of a gear or merely to provide a plurality of teeth extending from a rotatable target, in order to facilitate the detection of the teeth for the purpose of sensing the angular position or velocity of the rotating target. Devices of this type find many applications in automobiles, including sensors, which monitor the position of crankshafts and camshafts, and, in addition, sensors that are used in automatic braking systems.

FIG. 2 is a simplified schematic of a conventional target 20, which comprises a plurality of ferromagnetic members 22, which are spaced apart and separated by interstitial spaces 24. FIGS. 1 and 2 are provided for edification purposes only and are not to be construed as limiting the features of the present invention. As can be seen in FIG. 2, the interstitial spaces 24 and the ferromagnetic members 22 can vary in shape and size. For example, FIG. 2 illustrates some of the ferromagnetic members 22 as larger than others and some of the interstitial spaces 24 as larger than others. For example, the interstitial space identified, as G1 is much larger than interstitial space identified as G2. Because of the possible variation in size and spacing of the teeth, certain limitations are imposed on the ability of a geartooth sensor to accurately determine the presence and position of a geartooth within its detection zone.

FIG. 3 illustrates a conventional geartooth sensor configuration 30, which utilizes an angled face magnet 34. The configuration depicted in FIG. 3 is presented for edification and illustrative purposes only. FIG. 3 thus depicts a geartooth sensor configuration implemented to decrease variations in switching angles associated with a geartooth sensor. As indicated in FIG. 3, the angled face magnet 34 can be angularly positioned adjacent one or more sensing elements 32 utilized in association with the geartooth sensor. The sensing elements described herein, in accordance with a preferred embodiment of the present invention, can be configured as Hall elements, which are sensitive only to a magnetic field perpendicular to the plane of the Hall plate. Other types of sensing elements can be sensitive to the field in other directions; and if those other types are utilized instead of Hall elements, the physical orientation of the sensing elements may need to be adjusted appropriately to obtain the desired effect described herein. If only one sensing element is utilized, for example, its orientation might be different from that described herein in accordance with a preferred embodiment of the present invention. The angled face magnet can thus alter a magnetic signal thereof, thereby decreasing variations in switching angles associated the geartooth sensor relative to a sensor target 36. An analog signal provided by the sensing element is transmitted and input to a signal processing circuit, which converts the analog signal into a digital output signal (i.e., high or low) via the signal processing circuit.

It is important to note that waveforms produced by a magnetic sensor change in response to a varying air gap between the target and the sensor faces. Differences among biasing magnets utilized in a magnetic sensor, along with temperature, mechanical stresses, irregular target feature spacing, and so forth, can vary the sensor output. Therefore, the point at which the sensor changes state (i.e., the switch point), drifts or varies in time, in relation to the degree of rotation of the target. But the mechanical action of the engine as represented by the target does not change. That is, there is a “true point” on the target in angle, or degrees of rotation, related to a hardedge transition, which represents the point at which the sensor should change state to indicate a mechanical function of the engine.

Due to inherent limitations of the sensing system, the point at which the sensor changes state will generally vary by some amount from this true point. Therefore, the sensor can lose accuracy, such as, for example, being unable to provide a timing signal accurately representing piston travel. Therefore, the system controlled by the sensor can be inefficient due to these angular variations. By providing an angled face magnet, such as angled face magnet 34 of FIG. 3, such angular variations can be reduced. The problem with the configuration depicted in FIG. 3, however, is that this system provides a limited signal and also larger switching point variations over varying air gaps, which is undesired in sensing applications.

Geartooth sensors thus signal the passing of a target tooth or slot. Sensor output typically changes state (high to low or low to high) at particular angles dependent on the target geometry. The sensors exhibit a variation in the switching angle caused by sensor-to-target positioning tolerances and other variations.

Based on the foregoing, the present inventors have concluded that a need exists for improved sensing methods and systems for decreasing the variation in switching angles. In particular, the present inventors have concluded that a need exists for improved angular face magnet-based sensing devices. The present invention thus solves this need through the implementation of a unique method and system for decreasing switching angle variations caused by sensor-to-target positioning tolerances associated with magnetic sensors, such as, for example, geartooth sensors.

### BRIEF SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

It is, therefore, one aspect of the present invention to provide an improved magnetic sensor.

It is another aspect of the present invention to provide an improved geartooth sensor.

It is still another aspect of the present invention to provide an improved geartooth sensor that can be utilized in automobile applications.

It is yet another aspect of the present invention to provide a method and system for decreasing switching angle variations caused by sensor-to-target positioning tolerances associated with magnetic sensors, such as, for example, geartooth sensors.

It is still another aspect of the present invention to provide for an improved angular face magnet configuration for use in magnetic sensor applications.

The above and other aspects can be achieved as will now be summarized. A magnetic sensor method and system for decreasing variations in switching angles thereof is disclosed herein. An angled face magnet can be angularly positioned adjacent one or more sensing elements of a magnetic sensor thereof. The angled face magnet can be configured to include a recessed portion into which the one or more of the sensing elements can be positioned. When the teeth of a target pass by the angled face magnet, it produces a magnetic signal, which is steeper in switching regions. The angle face magnet can thus alter a magnetic signal thereof, thereby decreasing variations in switching angles associated the magnetic sensors relative to a sensor target. An analog signal provided by the sensing element is transmitted and input to a signal processing circuit, which converts the analog signal into a digital output signal (high or low) via the signal processing circuit. The magnetic sensor itself may comprise a geartooth sensor, such as, for example, geartooth sensors utilized in automobile applications. Such geartooth sensors can be utilized to determine crankshaft or camshaft angular positions. By utilizing an angled face magnet in the manner described herein, a resulting magnetic signal can thus be altered so that switching angle variations are decreased.

The novel features of the present invention will become apparent to those of skill in the art upon examination of the following detailed description of the invention or can be learned by practice of the present invention. It should be understood, however, that the detailed description of the invention and the specific examples presented, while indicating certain embodiments of the present invention, are provided for illustration purposes only because various changes and modifications within the scope of the invention will become apparent to those of skill in the art from the detailed description of the invention and claims that follow.

### BRIEF DESCRIPTION OF THE DRAWINGS

The accompanying figures, in which like reference numerals refer to identical or functionally-similar elements throughout the separate views and which are incorporated in and form part of the specification, further illustrate the present invention and, together with the detailed description of the invention, serve to explain the principles of the present invention.

FIG. 1 depicts a typical example of a conventional geartooth sensor;

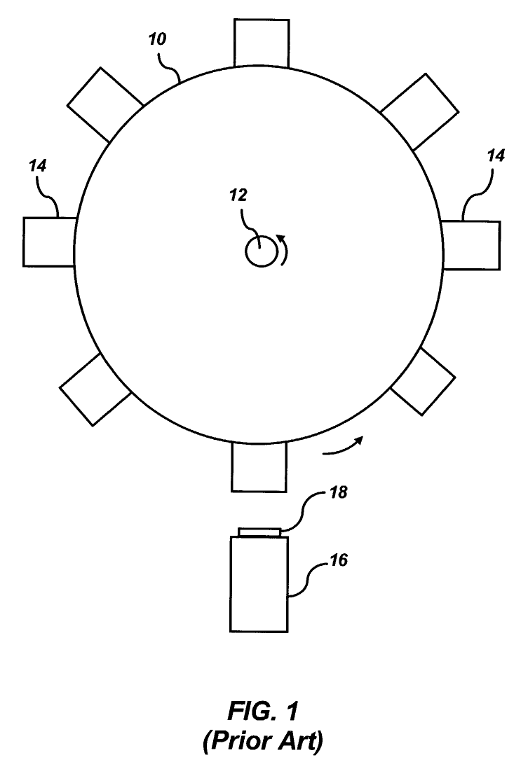

FIG. 2 depicts a simplified schematic diagram of a conventional target, which comprises a plurality of ferromagnetic members that are spaced apart and separated by interstitial spaces;

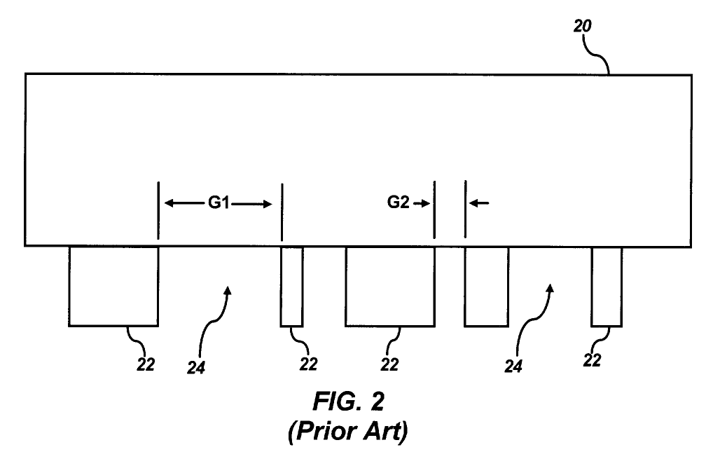

FIG. 3 depicts a conventional geartooth sensor configuration, which can utilize an angled face magnet;

FIG. 4 depicts a geartooth sensor configuration, which utilizes a partially angled face magnet, in accordance with a preferred embodiment of the present invention;

FIG. 5 depicts a general schematic diagram of a signal processing circuit utilized to convert an analog signal provided by a sensing element into a digital output signal, in accordance with a preferred embodiment of the present invention.

FIG. 6 depicts magnetic signals from a conventional differential Hall sensor for a target with a relatively large tooth;

FIG. 7 depicts magnetic signals from a sensor as depicted in FIG. 3 or FIG. 4 for the same target as indicated in FIG. 6;

FIG. 8 depicts a geartooth sensor configuration, in accordance with an alternative embodiment of the present invention; and

FIG. 9 illustrates a graph plotting data that compares the performance of a conventional sensor configuration to the performance of a sensor configuration implemented in accordance with a preferred embodiment of the present invention.

### DETAILED DESCRIPTION OF THE INVENTION

The particular values and configurations discussed in these non-limiting examples can be varied and are cited merely to illustrate an embodiment of the present invention and are not intended to limit the scope of the invention.

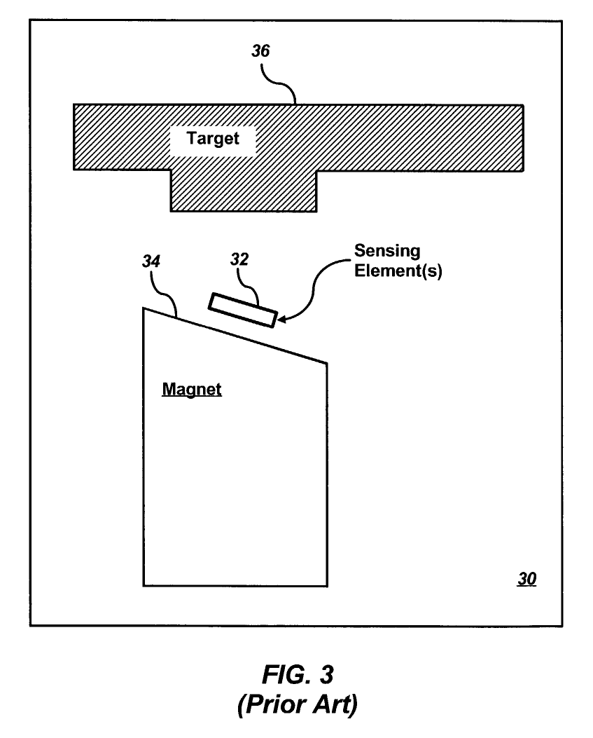

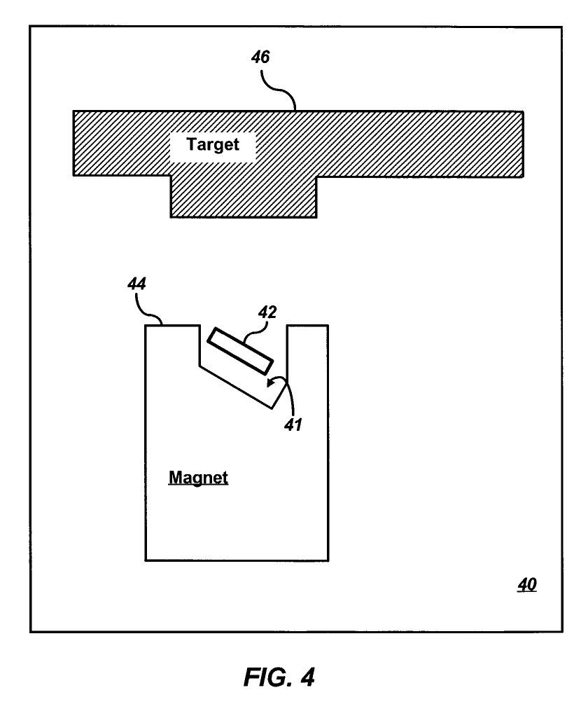

FIG. 4 depicts a geartooth sensor configuration 40, which utilizes a partially angled face magnet 44 with a portion of its face set at an angle, in accordance with a preferred embodiment of the present invention. Note that the magnet 44 illustrated in FIG. 4 is shaped differently than the angled face magnet 34, which is depicted in FIG. 3. The sensing element 42 is generally shown as being disposed within or beneath the surface plane of magnet 44. FIG. 4 thus depicts a geartooth sensor configuration, which may be implemented to decrease variations in switching angles associated with a geartooth sensor. FIG. 4 is intended to illustrate a magnet 44 with any portion of its face set at an angle and should not be limited to the central portion.

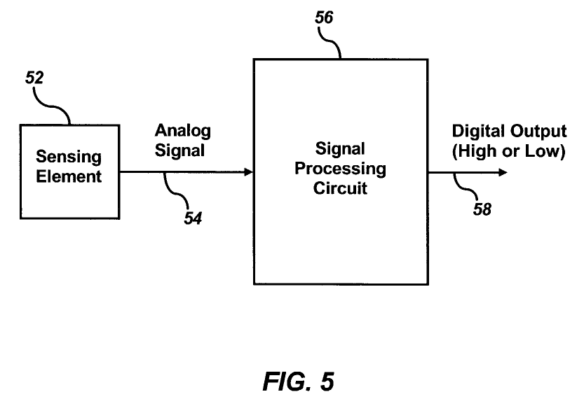

As indicated in FIG. 4, the magnet 44 can be angularly positioned adjacent one or more sensing elements 42 utilized in association with the geartooth sensor. Magnet 44 is formed to include a recessed portion 41 into which one or more sensing elements 42 can be positioned. The use of a recessed portion 41 in this manner thus can permit the angled face magnet 44 to alter a magnetic signal thereof, thereby decreasing variations in switching angles associated with the geartooth sensor relative to a sensor target 46. The non-angled portion 43 can be positioned close to the target, thereby creating a larger magnetic signal. The analog signal provided by one or more of the sensing elements 42 can be transmitted and input to a signal processing circuit (i.e., not shown in FIG. 4, but illustrated in FIG. 5), which can be utilized to convert the analog signal into a digital output signal (i.e., high or low) via the signal processing circuit.

FIG. 5 illustrates a general schematic diagram of a signal processing circuit 56, which can be utilized to convert an analog signal provided by a sensing element into a digital output signal in accordance with the present invention. In the configuration illustrated in FIG. 5, an analog signal 54 is provided by a sensing element 52 and transmitted to a signal processing circuit 56. The signal processing circuit 56 can be utilized to convert the analog signal into a digital output signal 58 (i.e., high or low). Note that sensing element 52 of FIG. 5 is analogous to sensing elements 32 and 42 of FIGS. 3 and 4. Although individual sensing elements 32, 42 and 52 are described and illustrated herein, it can be appreciated that a number of sensing elements can be arranged in a magnetic sensor configuration in accordance with the present invention.

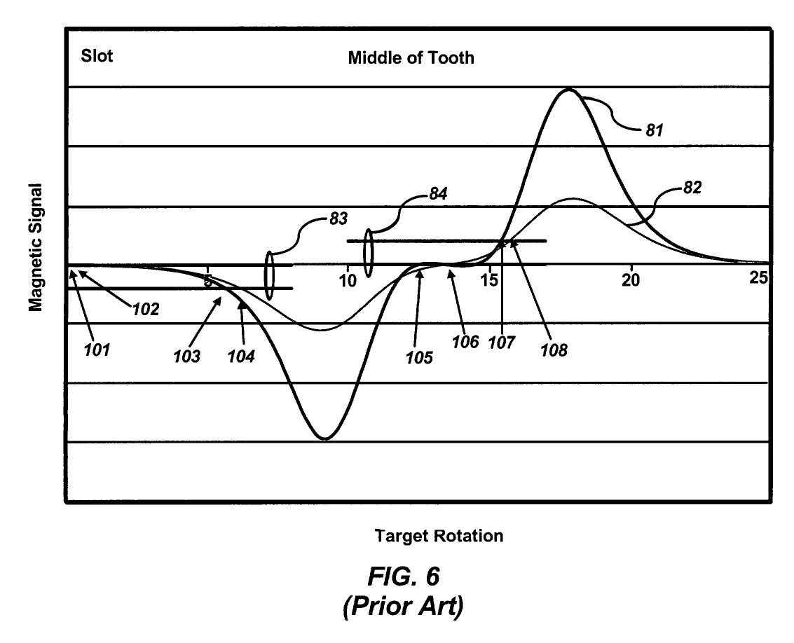

FIG. 6 illustrates a typical example of an analog magnetic signal of a conventional geartooth sensor, which utilizes a differential Hall configuration. FIG. 6 thus illustrates a plot of magnetic signal values versus target rotation values. As indicated in FIG. 6, a large signal 81 is typical for a sensor mounted near the geartooth target. The smaller signal 82 is typical for that same sensor except that the sensor is mounted further away from the geartooth target. Typical assembly procedures will result in this variation in mounting distances. Note that the signal is symmetrical about a zero gauss line.

Additionally, FIG. 6 illustrates two pairs of parallel lines 83 and 84. The pair of parallel lines 83 (i.e., illustrated at the left of FIG. 6) represents a range of signal levels over which a falling signal will switch. A range of signal levels is utilized due to part-to-part variation that results in a variation of the signal level at which the digital transition (i.e., sensor assembly output) can occur. Thus, switch point error is experienced due to the variation in angular position at which the digital transition occurs. Because both signals are flat inside the two levels, there is a very wide variation between switch point 101 and switch point 104.

The second pair of parallel lines 84, which are located centrally within the plot depicted in FIG. 6, represents the range of signal levels over which a rising signal can switch. Again, a range of signal levels is utilized due to part-to-part variation. Both signals are somewhat flat within the two levels, and there is a wide variation between switch point 105 and switch point 108. FIG. 6 therefore generally illustrates a graph of magnetic signal values versus target rotation values obtained from a conventional sensor.

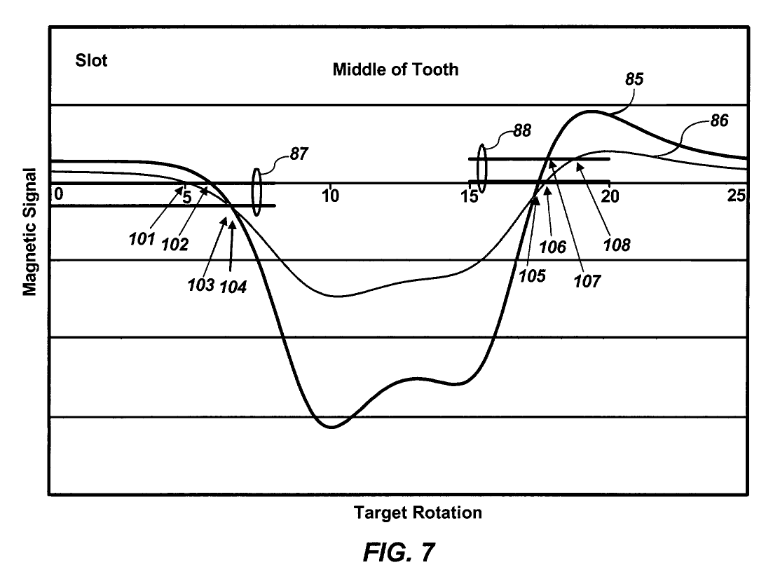

FIG. 7 indicates a plot of magnetic signal values versus target rotation. FIG. 7 illustrates an example of an analog signal that can be obtained from a geartooth sensor of the present invention, wherein a differential Hall configuration and an angled faced magnet are generally utilized 3. As depicted in FIG. 7, a large signal 85 is typical for a sensor mounted near the geartooth target. The smaller signal 86 is typical for that same sensor mounted further away from the geartooth target.

FIG. 7 also depicts two pairs of parallel lines 87 and 88. The pair of parallel lines 87 illustrated on the left of FIG. 7 represents a range of signal levels over which a falling signal can switch. Because the flat portion of the signals is generally above the two levels and the signals are steep while passing between these levels, there is far less variation between switch point 101 and switch point 104 of FIG. 7 than was indicated in the conventional sensor data plot illustrated in FIG. 6.

A second pair of parallel lines 88 illustrated centrally within the plot depicted in FIG. 7 represents a range of signal levels over which a rising signal can switch. Because both of the signals rise sharply through the two levels, there is less variation between switch point 105 and switch point 108 of FIG. 7 than was indicated in the conventional sensor data plot illustrated in FIG. 6. Note that similar reference numerals are illustrated in both FIGS. 6 and 7 to highlight and illustrate differences between conventional sensor configurations and a preferred embodiment of the present invention. Such similar reference numerals are presented for general edification and illustrative purposes only and are thus not considered limiting features of the present invention.

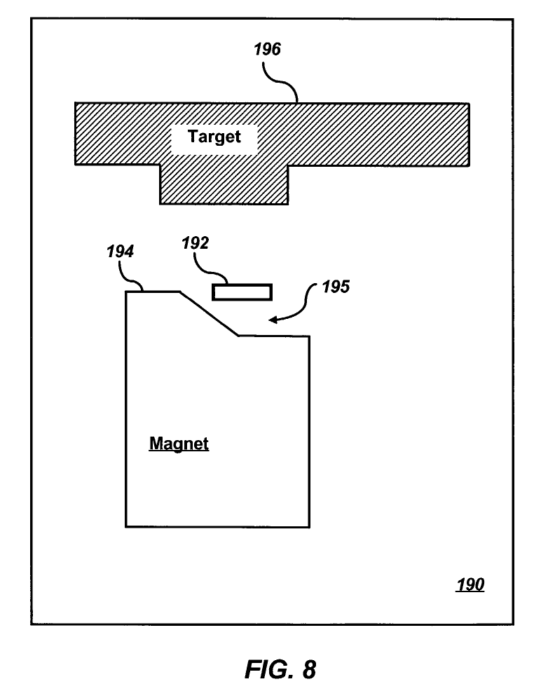

FIG. 8 illustrates a geartooth sensor configuration, which can be implemented in accordance with an alternative embodiment of the present invention. As depicted in FIG. 8, a magnet 194 with a portion of its face set at an angle can be positioned adjacent to one or more sensing elements 192 which can be utilized in association with a geartooth sensor, in accordance with the present invention. Magnet 194 can be configured as a partially angled face magnet having a flat portion 195. The flat portions of the magnet place magnet material closer to the target than a fully angled face magnet shown in FIG. 3. In this manner, the angled face magnet contributes to the alteration of a magnetic signal thereof, resulting in decreases in switching angles associated with the geartooth sensor relative to a sensor target 196.

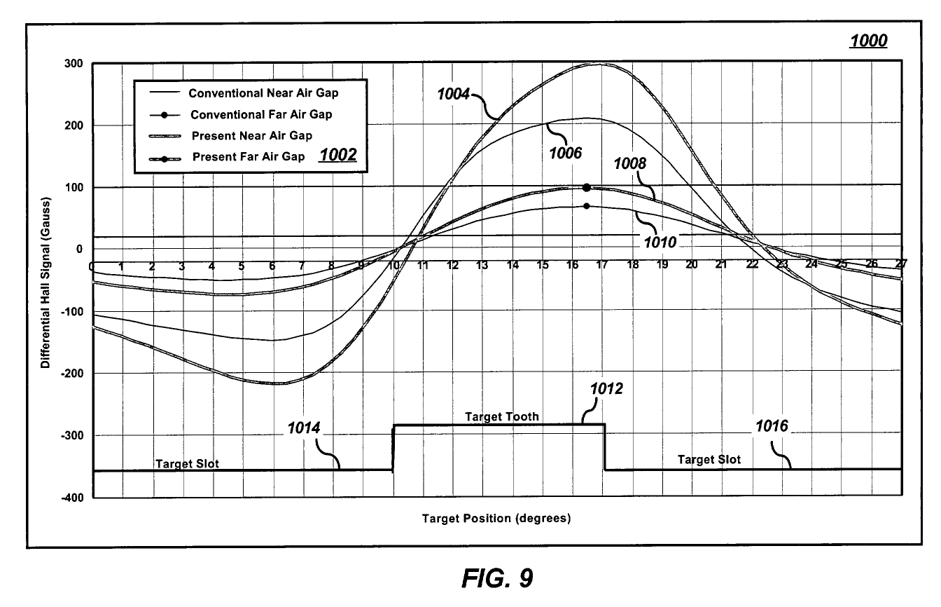

FIG. 9 depicts a graph 1000 illustrating results obtained from a conventional magnetic sensor (e.g., see FIG. 3) in comparison to results obtained from an implementation of the present invention (e.g., see FIG. 4). Graph 1000 thus illustrates a plot of differential Hall signal data (i.e., measured in Gauss) versus target position (i.e., measured in degrees). The data depicted in FIG. 9 can be obtained from an implementation, such as, for example, the configuration depicted in FIG. 4. As indicated in FIG. 9, the data obtained from an implementation of the present invention (i.e., lines 1004 and 1008) provides significantly better performance than conventional sensor configurations (i.e., lines 1006 and 1010) by providing a larger signal and also smaller switching point variation over varying air gap.

The FIG. 4 configuration, in particular, provides better performance by placing the magnetic material closer to the target, which increases the magnetization of the target, so that the magnetic signal at the sensing elements is larger. A legend box 1002 is associated with lines 1004 to 1010. Additionally, target slot data 1014 and 1016 is indicated in graph 1000 along with target tooth data 1012.

The present invention thus discloses a method and system in a magnetic sensor for decreasing variations in switching angles thereof. An angled face magnet is angularly positioned adjacent at least one sensing element utilized in association with the magnetic sensor. The angled face magnet can thus alter a magnetic signal thereof, thereby decreasing variations in switching angles associated with the magnetic sensor relative to a sensor target. An analog signal provided by the sensing element is transmitted and input to a signal processing circuit, which converts the analog signal into a digital output signal (i.e., high or low) via the signal processing circuit. The magnetic sensor itself may comprise a geartooth sensor, such, for example, geartooth sensors utilized in automobile applications. Such geartooth sensors can be utilized to determine crankshaft or camshaft angular positions.

By utilizing an angled face magnet with a magnet shape that places additional magnet material closer to the target in the manner described herein, a resulting magnetic signal can thus be altered so that switching angle variations are decreased. An example of a geartooth sensor configuration that can be implemented in accordance with the present invention can involve the placing of a ferrous target wheel on the crank shaft of an automobile engine with the sensor located proximate thereto. The target objects or features, i.e., tooth and slot, are of course properly keyed to the mechanical operation of the automobile engine components.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered. The description as set forth is not intended to be exhaustive or to limit the scope of the invention. Many modifications and variations are possible in light of the above teaching without departing from the spirit and scope of the following claims. It is contemplated that the use of the present invention can involve components having different characteristics. It is intended that the scope of the present invention be defined by the claims appended hereto, giving full cognizance to equivalents in all respects.

The embodiments of the invention in which an exclusive property or right is claimed are defined as follows. Having thus described the invention what is claimed is:

1. A method in a magnetic sensor for decreasing variations in switching angles thereof, said method comprising the steps of:
configuring an angled face magnet to include a recessed portion into which at least one sensing element can be positioned for magnetic sensing thereof;
positioning said at least one sensing element within said recessed portion of said angled face magnet, wherein said angled faced magnet is adapted for use with said magnetic sensor for sensing a sensor target thereof; and
altering a magnetic signal generated by said at least one sensing element of said magnetic sensor utilizing said angled face magnet, thereby decreasing variations in switching angles associated with said magnetic sensor relative to said sensor target.

2. The method of claim 1 further comprising the step of:
transmitting said magnetic signal from said at least one sensing element to a signal processing circuit, wherein said magnetic signal comprises an analog signal.

3. The method of claim 2 further comprising the step of:
converting said analog signal into a digital output signal via said signal processing circuit.

4. The method of claim 3 wherein said digital output signal comprises a high digital output signal.

5. The method of claim 3 wherein said digital output signal comprises a low digital output signal.

6. The method of claim 1 wherein said magnetic sensor comprises a geartooth sensor.

7. The method of claim 6 wherein said geartooth sensor is adapted for use in automobile applications.

8. The method of claim 6 wherein said geartooth sensor is adapted for use in automobile engines to determine crankshaft positions.

9. The method of claim 6 wherein said geartooth sensor is adapted for use in automobile engines to determine camshaft angular positions.

10. A method in a magnetic geartooth sensor for decreasing variations in switching angles thereof, said method comprising the steps of:
configuring an angled face magnet to include a recessed portion into which at least one sensing element can be positioned;
angularly positioning said at least one sensing element within said recessed portion of said angled face magnet, wherein said angled faced magnet is adapted for use with said magnetic geartooth sensor for sensing a geartooth sensor target thereof; and
altering a magnetic signal generated by said magnetic geartooth sensor utilizing said angled face magnet, thereby decreasing variations in switching angles associated with said magnetic geartooth sensor relative to said geartooth sensor target;
transmitting said magnetic signal to said at least one sensing element to a signal processing circuit, wherein said magnetic signal comprises an analog signal; and
converting said analog signal into a digital output signal via said signal processing circuit.

11. A system for decreasing variations in switching angles associated with a magnetic sensor, said system comprising:
an angled face magnet comprising a recessed portion into which at least one sensing element can be positioned for magnetic sensing thereof;
at least one sensing element positioned within said recessed portion of said angled face magnet, such that said angled faced magnet is adapted for use with said magnetic sensor for sensing a sensor target thereof; and
wherein said angled face magnet alters a magnetic signal generated by said at least one sensing element of said magnetic sensor, thereby decreasing variations in switching angles associated with said magnetic sensor relative to said sensor target.

12. The system of claim 11 further comprising the step of:
transmitting said magnetic signal from said at least one sensing element to a signal processing circuit, wherein said magnetic signal comprises an analog signal.

13. The system of claim 12 further comprising the step of:
converting said analog signal into a digital output signal via said signal processing circuit.

14. The system of claim 13 wherein said digital output signal comprises a high digital output signal.

15. The system of claim 13 wherein said digital output signal comprises a low digital output signal.

16. The system of claim 11 wherein said magnetic sensor comprises a geartooth sensor.

17. The system of claim 16 wherein said geartooth sensor is adapted for use in automobile applications.

18. The system of claim 16 wherein said geartooth sensor is adapted for use in automobile engines to determine crankshaft positions.

19. The system of claim 16 wherein said geartooth sensor is adapted for use in automobile engines to determine camshaft angular positions.

20. The system of claim 11 wherein said at least one sensing element comprises at least one Hall sensing element.
